(19) United States
(12) Patent Application Publication
(10) Pub. No.: US 2006/0099556 A1
(43) Pub. Date: May 11, 2006

(54) Method and apparatus for monitoring sports motion

(75) Inventors: Hyung-sok Yeo, Yongin-si (KR); Won-chul Bang, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/267,301

(22) Filed: Nov. 7, 2005

(30) Foreign Application Priority Data
Nov. 6, 2004 (KR) 10-2004-0090128

(51) Int. Cl. A63B 71/00; A63B 69/00; G09B 19/00

(52) U.S. Cl. 434/247; 482/8

(57) ABSTRACT

An apparatus and method of monitoring a sports motion are provided. The apparatus includes a sports motion monitoring apparatus which measures a physiological signal of a user performing a sports motion by being attached to the user, measures a sports motion signal according to a movement of the user or sports equipment, and transmits the physiological signal or the sports motion signal. The apparatus also includes a mobile terminal which obtains physiological information and sports motion information from the physiological signal and the sports motion signal, finds a period in which the user is in an optimum physiological state from the physiological information, calculates an optimum sports motion result from the sports motion information during the period, and informs the user of the optimum sports motion result.

### BACKGROUND OF THE INVENTION

This application claims priority from Korean Patent Application No. 10-2004-0090128, filed on Nov. 6, 2004 in the Korean Intellectual Property Office, the disclosure of which is incorporated herein in its entirety by reference.

1. Field of the Invention

Apparatuses and method consistent with the present invention relate to monitoring sports motions, and more particularly, to monitoring physiological conditions and sports motion of a user using a plurality of sensors when the user plays sports.

2. Description of the Related Art

Monitoring movements of a user while the user plays sports such as golf or tennis is performed mainly by recording moving picture information when the user plays sports and feeding back the recorded moving picture information to the user. The user needs a separate moving picture recording apparatus to record such moving picture information as well as an operator to operate the moving picture recording apparatus. In other words, it is difficult for the user to monitor the user's own movements while playing sports.

### SUMMARY OF THE INVENTION

The present invention provides a method and apparatus for monitoring sports motion of a user to provide information regarding optimum posture to the user by measuring and analyzing signals related to sports motion including a physiological signal and an acceleration signal of the user produced during sports motion by attaching a plurality of sensors on the body of the user or on sports equipment.

According to an aspect of the present invention, there is provided an apparatus for monitoring a sports motion, including: a sports motion monitoring apparatus which measures a physiological signal of a user performing a sports motion by being attached to the user, measures a sports motion signal according to a movement of the user or sports equipment, and transmits the physiological signal or the sports motion signal; and a mobile terminal which obtains physiological information and sports motion information from the physiological signal and the sports motion signal, finds a period in which the user is in an optimum physiological state from the physiological information, calculates an optimum sports motion result from the sports motion information during the period, and informs the user of the optimum sports motion result.

According to another aspect of the present invention, there is provided a method of monitoring a sports motion, including: attaching an apparatus for monitoring a sports motion on a user performing the sports motion or on a sports equipment; measuring a physiological signal of the user and a sports motion signal according to a movement of the user or the sports equipment, and transmitting the measured physiological signal and the sports motion signal; receiving the physiological signal and the sports motion signal, and obtaining physiological information and sports motion information from the physiological signal and the sports motion signal; obtaining a period in which the user is in an optimum physiological state from the physiological information; and calculating an optimum sports motion result from the sports motion information during the period, and informing the user of the optimum sports motion result.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a sports motion monitoring apparatus according to an exemplary embodiment of the present invention;

FIG. 2A is a view of a golf club on which the sports motion monitoring apparatus illustrated in FIG. 1 is mounted;

FIG. 2B is a view of the sports motion monitoring apparatus illustrated in FIG. 1 attached to a part of the body of the user;

FIG. 3 is a block diagram of a mobile terminal that receives and processes a signal output from the sports motion monitoring apparatus illustrated in FIG. 1; and

FIG. 4 is a graph illustrating an acceleration change of the golf club during a golf swing.

### DETAILED DESCRIPTION OF EXEMPLARY EMBODIMENTS OF THE INVENTION

The present invention will now be described more fully with reference to the accompanying drawings, in which exemplary embodiments of the invention are shown.

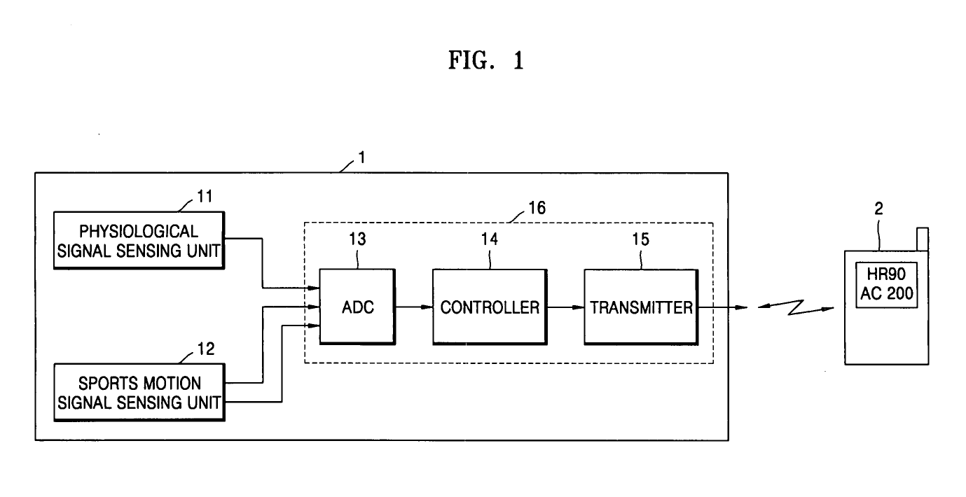

FIG. 1 is a block diagram of a sports motion monitoring apparatus 1 according to an exemplary embodiment of the present invention. The sports motion monitoring apparatus 1 illustrated in FIG. 1 may be attached to a part of a body of a user or to sports equipment.

The sports motion monitoring apparatus 1 includes a physiological signal sensing unit 11, a sports motion signal sensing unit 12, and a signal processing unit 16 including an analog-to-digital converter (ADC) 13, a controller 14, and a transmitter 15.

Reference numeral 2 indicates a mobile terminal which extracts information or sports motion information from a physiological signal or a sports motion signal received from the transmitter 15 and displays the information to the user. The mobile terminal 2 can be carried around by the user, and can display information received from the transmitter 15 and processed information. For example, the mobile terminal 2 may be a separate device which receives, processes, and displays the physiological or sports motion signals or a conventional communication terminal such as a PDA, a mobile phone, or a notebook computer.

The sports motion monitoring apparatus 1 is attached to the user or to the sports equipment and measures an acceleration of the motion of the user or the sports equipment. The sports motion monitoring apparatus 1 can optionally measure an angular velocity. To do this, the sports motion signal sensing unit 12 includes an acceleration sensor and optionally further includes an angular velocity sensor such as a gyroscope.

The physiological signal sensing unit 11 contacts a part of the body of the user or a part of the body that contacts the sports equipment (e.g., hands) and measures the physiological signal of the user. The sports motion signal sensing unit 12 measures the acceleration of a moving object, that is, the user or the sports equipment, and optionally measures the angular velocity using the angular velocity sensor.

The ADC 13 converts the measured physiological and sports motion signals into digital signals. The physiological and sports motion signals are distinguished by being input to and output from the ADC 13 through separate channels.

The controller 14 distinguishes the physiological signal from the sports motion signal, converts them into appropriate wireless signals, and transmits the wireless signals through the transmitter 15.

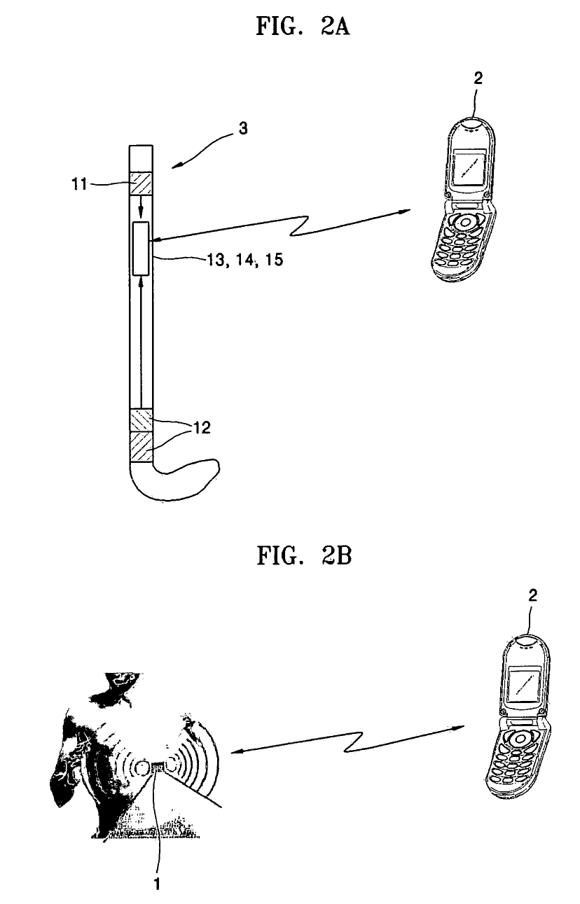

FIG. 2A is a view of a golf club 3 on which the sports motion monitoring apparatus 1 illustrated in FIG. 1 is mounted. The same reference numbers in FIGS. 1 and 2A denote like elements.

FIG. 2B is a view of the sports motion monitoring apparatus 1 illustrated in FIG. 1 attached to a part of the body of the user.

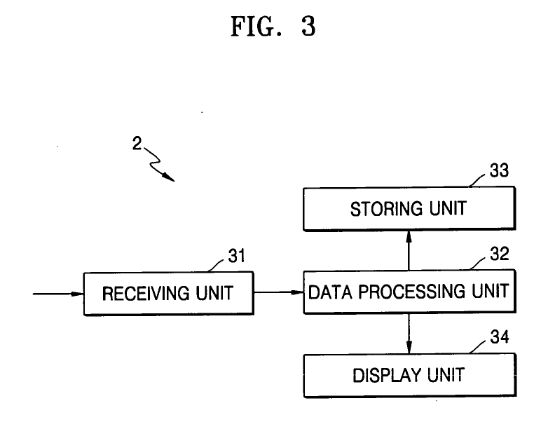

FIG. 3 is a block diagram of the mobile terminal 2 that receives and processes a signal output from the sports motion monitoring apparatus 1 illustrated in FIG. 1. The mobile terminal 2 includes a receiving unit 31, a data processing unit 32, a storing unit 33, and a display unit 34.

The receiving unit 31 receives the signal output from the sports motion monitoring apparatus 1.

The data processing unit 32 obtains physiological information from the physiological signal, and sports motion information such as acceleration and angular velocity information from the sports motion signal. The physiological information indicates a heart rate or autonomic nerve change information such as a Galvanic skin response (GSR), which indicates changes in the electric conductivity of the skin caused by psychological stimulus such as stress. The value of GSR is usually expressed in resistance.

The data processing unit 32 stores the physiological information and the sports motion information in the storing unit 33, and displays the information through the display unit 34.

The sports motion information obtained by the data processing unit 32 can indicate numerous information depending on a type of sports the user is presently playing. For example, when the user takes part in speed races such as running, cycling, rollerblading, or skiing while attaching the sports motion monitoring apparatus 1 on a part of the body of the user, the sports motion information can be sports motion velocity or rotation velocity of the user. The user's sports motion velocity and rotation velocity will be an integrated value of the accelerated velocity information over a predetermined time period and angular velocity information, respectively. Furthermore, the data processing unit 32 can calculate the user's movement distance based on the sports motion velocity or rotation velocity and provide the movement distance to the user.

In this case, the data processing unit 32 may provide information regarding changes in heart rate while performing sports based on the current heart rate and maximum target heart rate. The maximum target heart rate is a value calculated using a well-known Karvonen equation. According to the Karvonen equation, the maximum target heart rate is calculated as follows: (220−age−initial heart rate)×0.75+initial heart rate. Here, the initial heart rate is the average measured heart rate for an initial 10 seconds while resting, not exercising.

Also, the data processing unit 32 accumulates and stores predetermined points in the storing unit 33 while the user exercises when the heart rate measured in real-time lies within a valid range of 60% of the maximum heart rate for a predetermined amount of time, for example, five minutes. Then, the data processing unit 32 compares the stored points with the user's target points and provides the compared result to the user, thereby inducing interest of the user to improve sports motion performance ability and providing the motive to achieve the user's goal.

When the sports motion monitoring apparatus 1 is attached to a golf club, motion information includes various kinds of information related to the golf swing. The following is a detailed description regarding this situation.

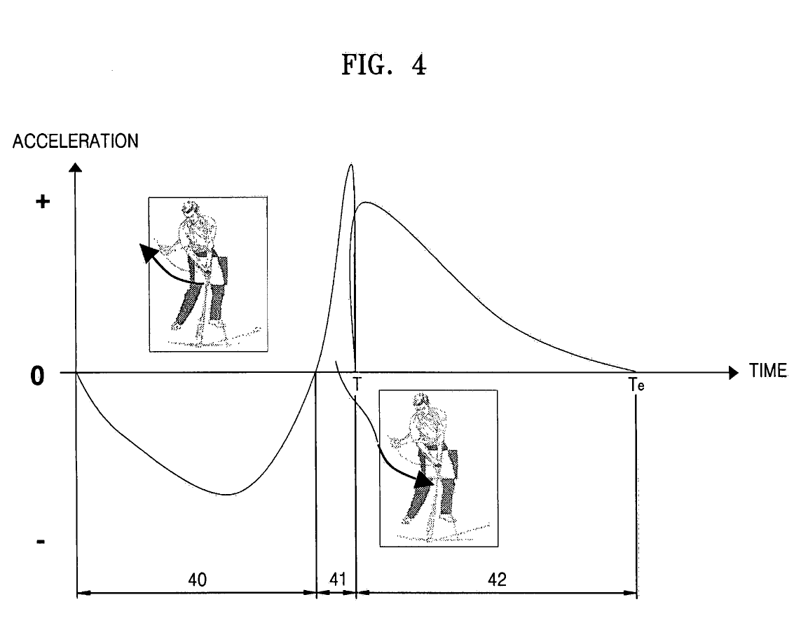

FIG. 4 is a graph illustrating a change in the acceleration of the golf club during the golf swing. Referring to FIG. 4, it is assumed that the back swing has a negative value while the forward swing has a positive value according to the movement direction of the golf club. A section indicated by reference number 40 shows an acceleration change of the golf club during the back swing, a section indicated by reference number 41 shows an acceleration change of the golf club during the downward swing until the golf club hits a golf ball, and a section indicated by reference number 42 shows an acceleration change of the golf club after the golf club hits the golf ball. Also, point to, a time point where the back swing ends, indicates an inflection point at which the negative value of the acceleration of the golf club changes into the positive value when the back swing changes to the downward swing. Point “T” indicates a golf ball hitting time point where the downward swing ends, and point Tₑ indicates a time point where the forward swing after hitting the golf ball ends.

The velocity of the golf club when hitting the golf ball obtained from the acceleration information can be derived from the following Equation.
v(t)=∫₀^{T}adt+v₀ (1)

Here, “a” is the acceleration information, and v₀ is the velocity of the golf club at the time point t₀.

Considering a pendulum movement which has a predetermined radius and angular velocity, the velocity of the pendulum can be calculated as the angular velocity “w” multiplied by the length of the pendulum “r” (i.e., v=r·w). If this is applied to the golf swing motion, “v” can be obtained by Equation 1, and “w” can be known from the angular velocity information. Thus, “r” can be obtained from “v” and “w.” A swing motion of the user becomes stable when there is no change in or a slight change in “r” when swinging the golf club. Therefore, an effective training for stabilizing the user's swing motion can be achieved by recording “r” when swinging the golf club and trying to reduce a standard deviation of the recorded “r.”

Besides the radius of the golf swing, an amount of impact the golf ball receives when the golf club hits the golf ball can be found from the acceleration information of the golf club. A large impact needs to be transferred to the golf ball in order to improve a carry distance of the golf ball. The impact the golf ball receives will be large if the acceleration of the golf club is large. Consequently, the posture of the user can be corrected to maximize the impact of the golf ball when the golf club hits the golf ball.

The velocity of the golf ball in flight can be calculated using the following Equation using the velocity of the golf club before and after the golf club hits the golf ball, and the mass of the golf club and the golf ball.
m_{c}v_{cl}=m_{c}v_{c2}+m_{b}v_{b} (2)

Here, m_{c} is the mass of the golf club, m_{b} is the mass of the golf ball, v_{cl} is the average velocity of the golf club from point t₀ to T, v_{c} is the average velocity of the golf club from T to Tₑ, and v_{b} is the velocity of the golf ball.

The carry distance of the golf ball per unit of time can be calculated by calculating the velocity of the golf ball using the above Equation 2.

Therefore, the optimum physiological state of the user when swinging the golf club and the optimum swinging information can be obtained from information such as the velocity of the golf club, the amount of impact given to the golf ball when the golf club hits the golf ball, the radius of the swing, or the carry distance of the golf ball. However, it is difficult to know the optimum physiological state or the swinging information through a single measurement. Thus, preferably, the optimum physiological state or the swinging information should be obtained repeatedly for several times.

In more detail, when measuring the swing motion of the user, the user performs the swing motion several times, and physiological information and motion information of the user measured for each swing is recorded. For every period of N, e.g., three or more, swing motions, a standard deviation for the heart rate or GSR is obtained. A period of the least standard deviation is determined to be the one in which the user is in his/her optimum physiological state.

The following Table shows the result of measuring the optimum physiological state of the user regarding the user's heart rate.

TABLE

| No. of Swings | Time | Heart Rate |
|---|---|---|
| 1 | 10:10:25 a.m. | 80 |
| 2 | 10:11:20 a.m. | 85 |
| 3 | 10:12:10 a.m. | 81 |
| 4 | 10:14:10 a.m. | 74 |
| 5 | 10:15:01 a.m. | 102 |
| . . . | . . . | . . . |
| 11 | 10:55:22 a.m. | 66 |
| 12 | 10:57:23 a.m. | 76 |
| 13 | 10:58:57 a.m. | 78 |
| 14 | 11:01:02 a.m. | ˜ |

According to the Table, it can be seen that a period of 11^{th} through 13^{th} swings has the least standard deviation of heart rate. When the physiological information is GSR, a period with the least standard deviation and an average of the GSR value calculated for at least three swings is determined to be the period of the optimum physiological state.

Then it is determined when the optimum swinging state is from the velocity of the golf club, the radius of the swing, and the carry distance of the golf ball per unit of time based on the sports motion information measured during the determined optimum physiological state period. The state of the optimum swing posture may be determined to be when the velocity and angular velocity of the swing of the golf club is the largest, when the radius of the swing is the smallest and when the carry distance of the golf ball per unit of time is the highest. However, because it is substantially difficult to determine the state of the optimum swing posture considering all of the above-described factors, the state of the optimum swing posture can be determined by the user's selection, considering any one of the velocity of the swing of the golf club, the angular velocity, the radius of the swing, and the carry distance of the golf ball per unit of time. For example, the state of the optimum swing posture can be determined considering only when the carry distance of the golf ball is the largest.

The data processing unit 32 determines the optimum physiological state and sports motion information as described above and stores the determined information in the storing unit 33. The data processing unit 32 sets a valid physiological state range and a valid sports motion pattern range based on the stored optimum physiological state and the sports motion information. The valid physiological state range and the valid sports motion pattern range can be set as a range set by the user based on the optimum physiological state and sports motion information stored in the storing unit 33, or can be set to be within the standard deviation of the physiological information and sports motion information in the period having the optimum physiological state.

The data processing unit 32 adds points if the result of the user's sports motion satisfy the valid physiological state range and the sports motion pattern range, but subtracts points if the result is unsatisfactory, and displays the total points. Therefore, the user can monitor the degree of improvement of the user's sports motion quantitatively.

According to exemplary embodiments of the present invention, physiological information and sports motion information of a user is measured, and an interest of a user regarding sports motion can be induced by adding or subtracting points to or from the user depending on whether the measured information satisfies a valid range. Thus, the user's sports motion performance ability may be improved. In addition, by feeding back to the user ideal sports motion pattern information for improving the user's sports motion performance ability, a quantitative training can be induced.

The invention can also be embodied as computer readable codes on a computer readable recording medium. The computer readable recording medium is any data storing unit device that can store data which can be thereafter read by a computer system. Examples of the computer readable recording medium include read-only memory (ROM), random-access memory (RAM), CD-ROMs, magnetic tapes, floppy disks, optical data storing unit devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for monitoring a sports motion, comprising:
a sports motion monitoring apparatus which is attached to a user and measures a physiological signal of the user performing a sports motion, measures a sports motion signal according to a movement of the user or of sports equipment, and transmits the physiological signal or the sports motion signal; and
a mobile terminal which obtains physiological information and sports motion information from the physiological signal and the sports motion signal, finds a period in which the user is in an optimum physiological state from the physiological information, calculates an optimum sports motion result from the sports motion information during the period, and informs the user of the optimum sports motion result.

2. The apparatus as claimed in claim 1, wherein the sports motion monitoring apparatus comprises:
a physiological signal measuring unit which measures the physiological signal;
a sports motion signal measuring unit which measures the sports motion signal; and
a signal processing unit which converts the physiological signal and the sports motion signal into different wireless signals and transmits the wireless signals.

3. The apparatus as claimed in claim 1, wherein the mobile terminal comprises:
a storing unit which stores the physiological information and the sports motion information;
a data processing unit which obtains the physiological information and the sports motion information from the physiological signal and the sports motion signal and stores the physiological information and the sports motion information in the storing unit, determines a period, in which a predetermined number of sports motions is performed, having a least standard deviation by calculating standard deviations of the physiological information for a plurality of periods, and outputs an optimum sports motion result from the obtained sports motion information during the period; and
a display unit which displays the result output from the data processing unit to the user.

4. The apparatus as claimed in claim 3, wherein the sports motion signal comprises an acceleration signal when the apparatus is attached to the user.

5. The apparatus as claimed in claim 4, wherein the data processing unit calculates acceleration information from the acceleration signal, calculates a distance traveled by the user from the acceleration information, and outputs the distance traveled to the display unit.

6. The apparatus as claimed in claim 3, wherein the data processing unit adds points in the storing unit if the physiological information is within a valid range of a target value for a predetermined time, and subtracts points if the physiological information is not within the valid range of the target value, and outputs the points to the display unit.

7. The apparatus as claimed in claim 3, wherein the sports motion signal comprises an acceleration signal and an angular velocity signal if the apparatus is attached to the sports equipment.

8. The apparatus as claimed in claim 7, wherein the data processing unit obtains acceleration and angular velocity information from the acceleration signal and an angular velocity signal, and outputs to the display unit information including at least one of a swing velocity, an angular velocity, a radius of the swing of the sports equipment, and a carry distance of an object hit by the sports equipment.

9. The apparatus as claimed in claim 8, wherein the data processing unit adds points in the storing unit if the information including at least one of the swing velocity, the angular velocity, the radius of the swing of the sports equipment, and the carry distance of the object hit by the sports equipment is within a corresponding valid range for a predetermined time, or subtracts points in the storing unit if the information is not within the valid range, and outputs the points to the display unit.

10. A method of monitoring a sports motion, comprising:
attaching an apparatus for monitoring a sports motion on a user performing the sports motion or on a sports equipment;
measuring a physiological signal of the user and measuring a sports motion signal according to a movement of the user or of the sports equipment, and transmitting the physiological signal and the sports motion signal;
receiving the physiological signal and the sports motion signal, and obtaining physiological information and sports motion information from the physiological signal and the sports motion signal;
obtaining a period in which the user is in an optimum physiological state from the physiological information; and
calculating an optimum sports motion result from the sports motion information during the period, and informing the user of the optimum sports motion result.

11. The method as claimed in claim 10, wherein the physiological information comprises autonomic nerve change information including at least one of a heart rate and a skin electric response value.

12. The method as claimed in claim 11, wherein the period is determined to have the least standard deviation of the physiological information during which a predetermined number of sports motions is performed.

13. The method as claimed in claim 10, wherein the sports motion signal comprises an acceleration signal regarding a movement of a first object to which the apparatus is attached.

14. The method as claimed in claim 13, wherein in the informing of the user of the optimum sports motion result, points are added if the physiological information is within a valid range of a target value for a predetermined time, and points are subtracted if the physiological information is not within the valid range, and the points is informed to the user.

15. The method as claimed in claim 13, wherein the sports motion signal further comprises an angular velocity signal regarding the movement of the first object to which the apparatus is attached.

16. The method as claimed in claim 15, wherein the sports motion information includes at least one of a swing velocity, an angular velocity, a radius of the swing of the sports equipment, and a carry distance of a second object hit by the sports equipment.

17. The method as claimed in claim 16, wherein in the informing of the user of the points, points are added if information including at least one of the swing velocity, the angular velocity, the radius of the swing of the sports equipment, and the carry distance of the second object hit by the sports equipment is within a corresponding valid range for a predetermined time, points are subtracted if the information is not within the valid range, and the points is informed to the user.
